(19) United States
(12) Patent Application Publication
(10) Pub. No.: US 2015/0035763 A1
(43) Pub. Date: Feb. 5, 2015

(54) INFORMATION TERMINAL APPARATUS

(71) Applicant: Kabushiki Kaisha Toshiba, Tokyo (JP)

(72) Inventors: Tsukasa Matoba, Kanagawa (JP); Mineharu Uchiyama, Kanagawa (JP); Keiichiro Mori, Kanagawa (JP)

(73) Assignee: KABUSHIKI KAISHA TOSHIBA, Tokyo (JP)

(21) Appl. No.: 14/206,604

(22) Filed: Mar. 12, 2014

(30) Foreign Application Priority Data
Aug. 1, 2013 (JP) 2013-160536

(51) Int. Cl. G06F 3/041

(52) U.S. Cl. CPC G06F 3/041
USPC 345/173

(57) ABSTRACT

According to an embodiment, an information terminal apparatus includes: a display device equipped with a touch panel; a position detecting section configured to detect a position of a finger in a space which includes a predetermined three-dimensional motion judgment space FDA set in advance separated from a display surface of the display device; and a position information transmitting section configured to transmit position information about the finger in the motion judgment space detected by the position detecting section before the touch panel is touched.

### CROSS-REFERENCE TO RELATED APPLICATION

This application is based upon and claims the benefit of priority from the Japanese Patent Application No. 2013-160536, filed on Aug. 1, 2013; the entire contents of which are incorporated herein by reference.

### FIELD

An embodiment described herein relates generally to an information terminal apparatus.

### BACKGROUND

Recently, information terminal apparatuses such as a smartphone, a tablet terminal and a digital signage have become widespread. These information terminal apparatuses have a display device equipped with a touch panel.

By touching the display device mounted with a touch panel, a user can select a displayed object such as a product. For example, in the case of information search, the object is a display of a search result. When an object is selected, information about the selected object is notified to a server or the like. The server generates further related information according to the information about the selected object and transmits the information to the information terminal apparatus, and the information is displayed on the display device of the information terminal apparatus. Information terminal apparatuses are widely used not only by individuals but also in companies and the like for information search and the like.

For example, a smartphone user can access a mail order site selling products and select a product from a group of products displayed on a screen of a display device and purchase the product. In this case, by touching an image of a desired product in the group of products displayed on the screen of the smartphone, the user selects the product. A server of such a mail order site analyzes information about the product the user has selected, analyzes the user's taste and advertises such as displaying product information suiting the user's taste on a site screen for the user.

That is, in an information terminal apparatus equipped with a touch panel, processing according to a selection operation of touching the touch panel is performed, and information about an object selected by the touch is transmitted to a server.

However, in conventional information terminal apparatuses such as a smartphone, it is not possible to acquire information about a process until selection of an object by a user. For example, a conventional information terminal apparatus or server cannot acquire information about which objects a user is interested in until he selects one or more objects from a group of objects displayed on a display device of the information terminal apparatus. That is, the conventional information terminal apparatus cannot acquire information about which objects other than the objects selected by the user in the end have been selection candidates for the user.

### BRIEF DESCRIPTION OF THE DRAWINGS

FIG. 1 is an overview diagram of a tablet terminal which is an information terminal apparatus according to an embodiment;

FIG. 2 is a block diagram showing a configuration of a tablet terminal 1 according to the embodiment;

FIG. 3 is a diagram for illustrating a motion judgment space FDA which is an area for detecting a motion of a finger above and separated from a display area 3a and judging occurrence of an event, according to the embodiment;

FIG. 4 is a diagram for illustrating light emission timings of respective light emitting sections 6 and light receiving timings of a light receiving section 7 according to the embodiment;

FIG. 5 is a diagram for illustrating optical paths through which lights emitted from the light emitting sections 6 are received by the light receiving section 7 seen from above the display area 3a of the tablet terminal 1 according to the embodiment;

FIG. 6 is a graph showing a relationship between a position of a finger F in an X direction and a rate Rx according to the embodiment;

FIG. 7 is a diagram for illustrating optical paths through which lights emitted from the light emitting sections 6 are received by the light receiving section 7 seen from above the display area 3a of the tablet terminal 1 according to the embodiment;

FIG. 8 is a graph showing a relationship between a position of a finger F in a Y direction and a rate Ry according to the embodiment;

FIG. 9 is a diagram for illustrating the optical paths through which lights emitted from the light emitting sections 6 are received by the light receiving section 7 seen from a left side of the tablet terminal 1 according to the embodiment;

FIG. 10 is a diagram for illustrating the optical paths through which lights emitted from the light emitting sections 6 are received by the light receiving section 7 seen from an upper side of the tablet terminal 1 according to the embodiment;

FIG. 11 is a graph showing a relationship between a position of a finger F in a Z direction and a sum SL of three amounts of light received according to the embodiment;

FIG. 12 is a flowchart showing an example of a flow of a finger motion information transmitting process according to the embodiment;

FIG. 13 is a diagram showing an example of a table TBL in which position information and the like are recorded, according to the embodiment; and

FIG. 14 is a block diagram showing components for the finger motion information transmitting process in FIG. 12.

### DETAILED DESCRIPTION

An information terminal apparatus of an embodiment includes: a display device equipped with a touch panel; a position detecting section configured to detect a position of a material body in a space which includes a predetermined three-dimensional space set in advance separated from a display surface of the display device; and a position information transmitting section configured to transmit position information about the material body in the predetermined space detected by the position detecting section before the touch panel is touched.

The embodiment will be described below with reference to drawings.

### (Configuration)

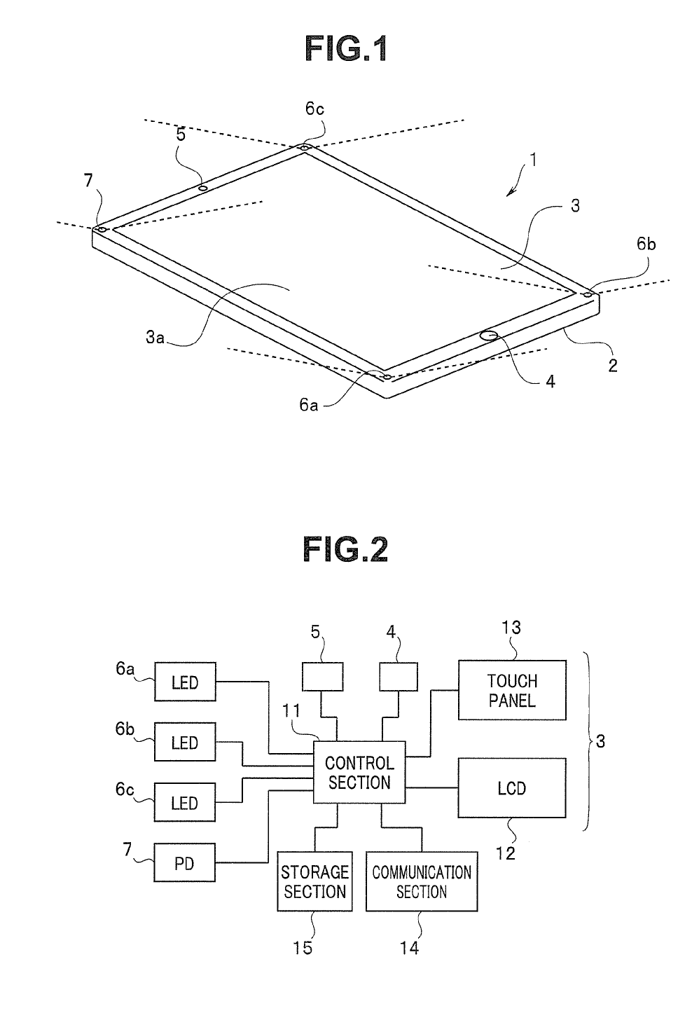

FIG. 1 is an overview diagram of a tablet terminal which is an information terminal apparatus according to an embodiment.

Note that, though a tablet terminal is described as an example of the information terminal apparatus, the information terminal apparatus may be a smartphone, digital signage or the like which is equipped with a touch panel.

A tablet terminal 1 has a thin plate shaped body section 2 and a rectangular display area 3a of a display device 3 equipped with a touch panel is arranged on an upper surface of the body section 2 so that an image is displayed on the rectangular display area 3a. A switch 4 and a camera 5 are also arranged on an upper surface of the tablet terminal 1. A user can connect the tablet terminal 1 to the Internet to browse various kinds of sites or execute various kinds of pieces of application software. On the display area 3a, various kinds of site screens or various kinds of screens generated by the various kinds of pieces of applications are displayed.

The switch 4 is an operation section operated by the user to specify on/off of the tablet terminal 1, jump to a predetermined screen, and the like.

The camera 5 is an image pickup apparatus which includes an image pickup device, such as a CCD, for picking up an image in a direction opposite to a display surface of the display area 3a.

Three light emitting sections 6a, 6b and 6c and one light receiving section 7 are arranged around the display area 3a of the tablet terminal 1.

More specifically, the three light emitting sections 6a, 6b and 6c (hereinafter also referred to as the light emitting sections 6 in the case of referring to the three light emitting sections collectively or the light emitting section 6 in the case of referring to any one of the light emitting sections) are provided near three corner parts among four corners of the rectangular display area 3a, respectively, so as to radiate lights with a predetermined wavelength within a predetermined range in a direction intersecting the display surface of the display area 3a at a right angle as shown by dotted lines.

The light receiving section 7 is provided near one corner part among the four corners of the display area 3a where the three light emitting sections 6 are not provided so as to receive lights within a predetermined range as shown by dotted lines. That is, the three light emitting sections 6a, 6b and 6c are arranged around the display surface of the display device 3, and the light receiving section is also arranged around the display surface.

Each light emitting section 6 has a light emitting diode (hereinafter referred to as an LED) configured to emit a light with a predetermined wavelength, a near-infrared light here, and an optical system such as a lens. The light receiving section 7 has a photodiode (PD) configured to receive a light with a predetermined wavelength emitted by each light emitting section 6, and an optical system such as a lens. Since the near-infrared light, the wavelength of which is longer than that of a visible red light is used here, the user cannot see the light emitting section 6 emitting the light. That is, each light emitting section 6 emits a near-infrared light as a light with a wavelength outside a wavelength range of visible light.

An emission direction of lights emitted from the light emitting sections 6 is within a predetermined range in the direction intersecting the surface of the display area 3a at a right angle, and a direction of the light receiving section 7 is set so that the light emitted from each light emitting section 6 is not directly inputted into the light receiving section 7.

That is, each light emitting section 6 is arranged so as to have such an emission range that a light is emitted to a space which includes a motion judgment space FDA on an upper side of the display area 3a, which is to be described later, by adjusting a direction or the like of the lens of the optical system provided on an emission side. Similarly, the light receiving section 7 is also arranged so as to have such an incidence range that a light enters from the space which includes the motion judgment space FDA on the upper side of the display area 3a, which is to be described later, by adjusting a direction or the like of the lens of the optical system provided on an incidence side.

FIG. 2 is a block diagram showing a configuration of the tablet terminal 1. As shown in FIG. 2, the tablet terminal 1 is configured, being provided with a control section 11, a liquid crystal display device (hereinafter referred to as an LCD) 12, a touch panel 13, a communication section 14 for wireless communication, a storage section 15, the switch 4, the camera 5, the three light emitting sections 6 and the light receiving section 7. The LCD 12, the touch panel 13, the communication section 14, the storage section 15, the switch 4, the camera 5, the three light emitting sections 6 and the light receiving section 7 are connected to the control section 11.

The control section 11 includes a central processing unit (hereinafter referred to as a CPU), a ROM, a RAM, a bus, a rewritable nonvolatile memory (for example, a flash memory) and various kinds of interface sections. Various kinds of programs are stored in the ROM and the storage section 15, and a program specified by the user is read out and executed by the CPU.

The LCD 12 and the touch panel 13 constitute the display device 3. That is, the display device 3 is a display device equipped with a touch panel. The control section 11 receives a touch position signal from the touch panel 13 and executes predetermined processing based on the inputted touch position signal. The control section 11 provides a graphical user interface (GUI) on a screen of the display area 3a by generating and outputting screen data to the LCD 12 which has been connected.

The communication section 14 is a circuit for performing wireless communication with a network such as the Internet and a LAN, and performs the communication with the network under the control of the control section 11.

The storage section 15 is a mass storage device such as a hard disk drive device (HDD) and a solid-state drive device (SSD). Not only the various kinds of programs but also various kinds of data are stored.

The switch 4 is operated by the user, and a signal of the operation is outputted to the control section 11.

The camera 5 operates under the control of the control section 11 and outputs an image pickup signal to the control section 11.

As described later, each light emitting section 6 is driven by the control section 11 in predetermined order to emit a predetermined light (here, a near-infrared light).

The light receiving section 7 receives the predetermined light (here, the near-infrared light emitted by each light emitting section 6) and outputs a detection signal according to an amount of light received, to the control section 11.

The control section 11 controls light emission timings of the three light emitting sections 6 and light receiving timings of the light receiving section 7, and executes predetermined operation and judgment processing to be described later, using a detection signal of the light receiving section 7. When predetermined conditions are satisfied, the control section 11 transmits predetermined data via the communication section 14.

In the present embodiment, a space for detecting a motion of a finger within a three-dimensional space on the display area 3a is set, and a motion of the user's finger within the space is detected. Though position information about a finger is acquired in description below, the position information may be position information about a material body other than a finger, such as a pen point since the touch panel 13 can be operated with a pen point.

(Position Detection of Finger within Three-Dimensional Space on Display Area)

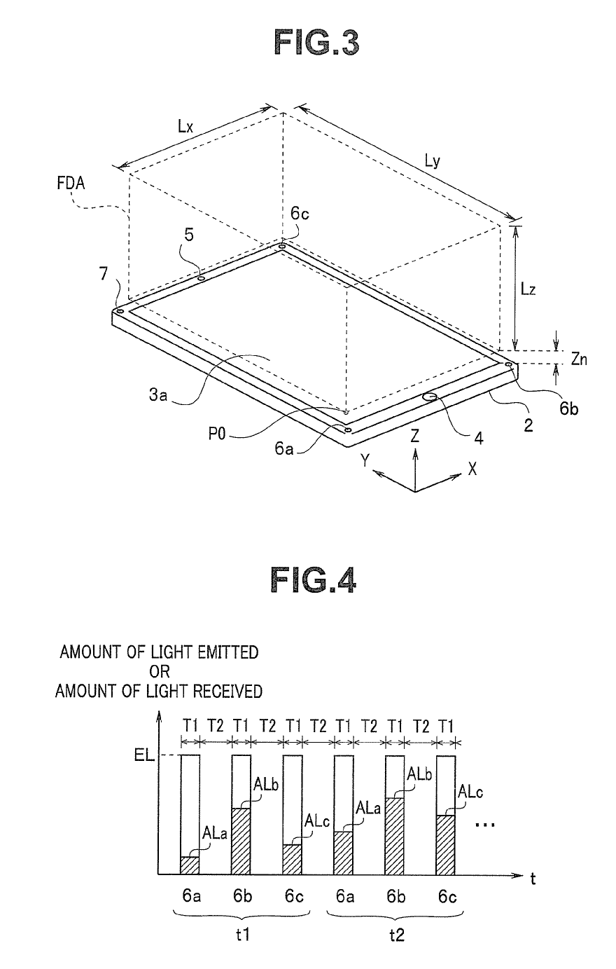

FIG. 3 is a diagram for illustrating the motion judgment space FDA which is an area for detecting a motion of a finger above and separated from the display area 3a and judging occurrence of an event.

As shown in FIG. 3, the motion judgment space FDA of the present embodiment is a cuboid space set above and separated from the display area 3a. Here, when it is assumed that, in the motion judgment space FDA, a direction of a line connecting the light emitting sections 6a and 6b is an X direction, a direction of a line connecting the light emitting sections 6b and 6c is a Y direction, and a direction intersecting the surface of the display area 3a is a Z direction, the motion judgment space FDA is a cuboid space extending toward the Z direction from a position separated from the display area 3a in the Z direction by a predetermined distance Zn, along a rectangular frame of the display area 3a. Therefore, the motion judgment space FDA is a cuboid having a length of Lx in the X direction, a length of Ly in the Y direction and a length of Lz in the Z direction. For example, Lz is a length within a range of 10 to 20 cm.

The motion judgment space FDA is specified at a position separated from the surface of the display area 3a by the predetermined distance Zn. This is because there is a height range in the Z direction where the light receiving section 7 cannot receive a reflected light from a finger F. Therefore, the motion judgment space FDA is set within a range except the range where light receiving is impossible. Here, as shown in FIG. 3, a position at a left end of the X direction, a bottom end of the Y direction and a bottom end of the Z direction is assumed to be a reference point P0 of the position of the motion judgment space FDA.

FIG. 4 is a diagram for illustrating light emission timings of the light emitting sections 6 and light receiving timings of the light receiving section 7. In FIG. 4, a vertical axis indicates an amount of light emitted or an amount of light received, and a horizontal axis indicates a time axis.

The control section 11 causes the three light emitting sections 6a, 6b and 6c in predetermined order with a predetermined amount of light EL. As shown in FIG. 4, the control section 11 causes the light emitting section 6a among the three light emitting sections 6 to emit a light during a predetermined time period T1 first and, after elapse of a predetermined time period T2 after light emission by the light emitting section 6a, causes the light emitting section 6b to emit a light during the predetermined time period T1. Then, after elapse of the predetermined time period T2 after light emission by the light emitting section 6b, the control section 11 causes the light emitting section 6c to emit a light for the predetermined time period T1. Then, after elapse of the predetermined time period T2 after light emission by the light emitting section 6c, the control section 11 causes the light emitting section 6a to emit a light for the predetermined time period T1 and subsequently causes the second light emitting section 6b to emit a light. In this way, the control section 11 repeats causing the first to third light emitting sections 6a, 6b and 6c to emit a light in turn.

That is, the three light emitting sections 6a, 6b and 6c emit lights at mutually different timings, respectively, and the light receiving section 7 detects reflected lights of the lights emitted by the three light emitting sections 6a, 6b and 6c, respectively, according to the different timings.

The control section 11 causes the three light emitting sections 6 at predetermined light emission timings as described above as well as acquiring a detection signal of the light receiving section 7 at a predetermined timing within the predetermined time period T1, which is a light emission time period of each light emitting section 6.

In FIG. 4, it is shown that an amount of light received ALa is an amount of light detected by the light receiving section 7 when the light emitting section 6a emits a light, an amount of light received ALb is an amount of light detected by the light receiving section 7 when the light emitting section 6b emits a light, and an amount of light received ALc is an amount of light detected by the light receiving section 7 when the light emitting section 6c emits a light. The control section 11 can receive a detection signal of the light receiving section 7 and obtain information about an amount of light received corresponding to each light emitting section 6.

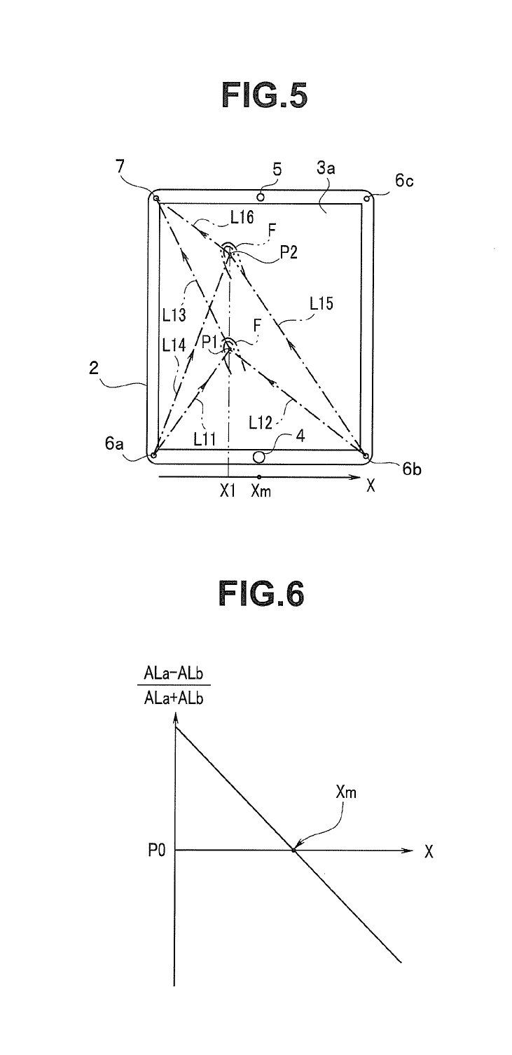

FIG. 5 is a diagram for illustrating optical paths through which lights emitted from the light emitting sections 6 are received by the light receiving section 7 seen from above the display area 3a of the tablet terminal 1. FIG. 5 is a diagram for illustrating estimation of a position of the finger F in the X direction.

In FIG. 5, a position P1 is a position slightly left in the X direction and slightly lower in the Y direction when seen from above the display area 3a of the tablet terminal 1. A position P2 is a position slightly left in the X direction and slightly upper in the Y direction. However, the X-direction positions X1 of the positions P1 and P2 are the same.

When the finger F is at the position P1 above and separated from the display area 3a without touching the display device 3 (that is, without touching the touch panel 13), a light which hits the finger F, is reflected by the finger F and enters the light receiving section 7, among lights emitted from the light emitting section 6a, passes through optical paths L11 and L13 shown in FIG. 5, and a light which hits the finger F, is reflected by the finger F and enters the light receiving section 7, among lights emitted from the light emitting section 6b, passes through optical paths L12 and L13 shown in FIG. 5.

When the finger F is at the position P2 above and separated from the display area 3a without touching the display device 3 (that is, without touching the touch panel 13), a light which hits the finger F, is reflected by the finger F and enters the light receiving section 7, among lights emitted from the light emitting section 6a passes through optical paths L14 and L16 shown in FIG. 5, and a light which hits the finger F, is reflected by the finger F and enters the light receiving section 7, among lights emitted from the light emitting section 6b, passes through optical paths L15 and L16 shown in FIG. 5.

Since the light receiving section 7 receives lights according to the light emission timings shown in FIG. 4 and outputs detection signals to the control section 11, the control section 11 acquires an amount-of-light-received signal corresponding to each light emitting section 6 from the light receiving section 7. The position of the finger F in the three-dimensional space is calculated as shown below.

From the amount of light received ALa of a reflected light of a light from the light emitting section 6a and the amount of light received ALb of a reflected light of a light from the light emitting section 6b, a rate Rx shown by a following equation (1) is calculated.

Rx=((ALa−ALb)/(ALa+ALb)) (1)

The rate Rx increases as the amount of light received ALa increases in comparison with the amount of light received ALb, and decreases as the amount of light received ALa decreases in comparison with the amount of light received ALb.

When the positions in the X direction are the same position, as shown by the positions P1 and P2, the rate Rx is the same.

FIG. 6 is a graph showing a relationship between the position of the finger F in the X direction and the rate Rx. In the X direction, the rate Rx increases when the finger F is near the light emitting section 6a, and the rate Rx decreases when the finger F is near the light emitting section 6b. At a central position Xm in the X direction on the display area 3a, the rate Rx is 0 (zero).

Therefore, the position of the finger F in the X direction can be estimated by the equation (1) based on the amounts of light received of reflected lights of lights emitted from the light emitting sections 6a and 6b.

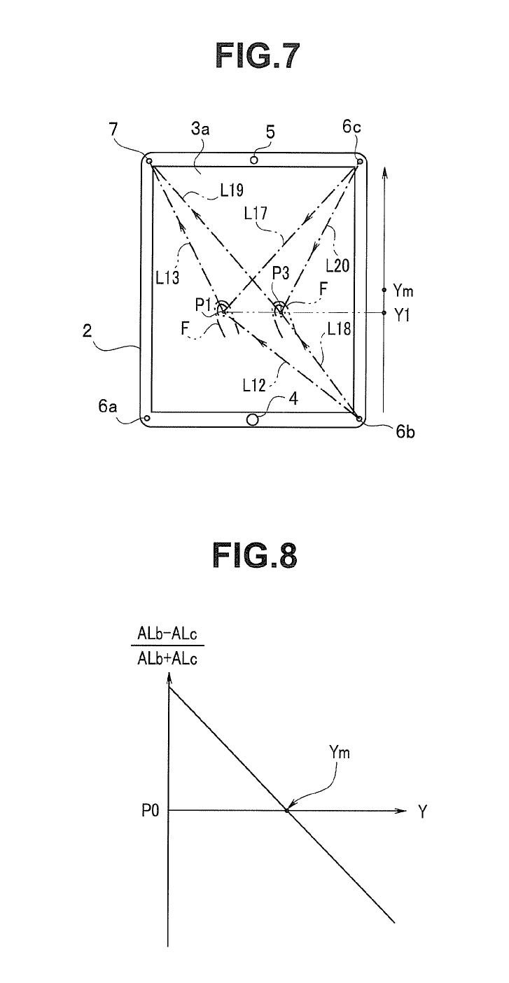

FIG. 7 is a diagram for illustrating optical paths through which lights emitted from the light emitting sections 6 are received by the light receiving section 7 seen from above the display area 3a of the tablet terminal 1. FIG. 7 is a diagram for illustrating estimation of the position of the finger F in the Y direction.

In FIG. 7, the position P1 is a position slightly left in the X direction and slightly lower in the Y direction when seen from above the display area 3a of the tablet terminal 1. A position P3 is a position slightly right in the X direction and slightly lower in the Y direction. However, the Y-direction positions Y1 of the positions P1 and P3 are the same.

When the finger F is at the position P1 above and separated from the display area 3a without touching the display device 3 (that is, without touching the touch panel 13), a light which hits the finger F, is reflected by the finger F and enters the light receiving section 7, among lights emitted from the light emitting section 6b, passes through the optical paths L12 and L13 similarly to FIG. 5, and a light which hits the finger F, is reflected by the finger F and enters the light receiving section 7, among lights emitted from the light emitting section 6c, passes through optical paths L17 and L13 shown in FIG. 7.

When the finger F is at the position P3 above and separated from the display area 3a without touching the display device 3 (that is, without touching the touch panel 13), a light which hits the finger F, is reflected by the finger F and enters the light receiving section 7, among lights emitted from the light emitting section 6b, passes through optical paths L18 and L19 shown in FIG. 7, and a light which hits the finger F, is reflected by the finger F and enters the light receiving section 7, among lights emitted from the light emitting section 6c, passes through optical paths L20 and L19 shown in FIG. 7.

Now, from the amount of light received ALb of a reflected light of a light from the light emitting section 6b and the amount of light received ALc of a reflected light of a light from the light emitting section 6c, a rate Ry shown by a following equation (2) is calculated.

Ry=((ALb−ALc)/(ALb+ALc)) (2)

The rate Ry increases as the amount of light received ALb increases in comparison with the amount of light received ALc, and decreases as the amount of light received ALb decreases in comparison with the amount of light received ALc.

When the positions in the Y direction are the same position, as shown by the positions P1 and P3, the rate Ry is the same.

FIG. 8 is a graph showing a relationship between the position of the finger F in the Y direction and the rate Ry. In the Y direction, the rate Ry increases when the finger F is near the light emitting section 6b, and the rate Ry decreases when the finger F is near the light emitting section 6c. At a central position Ym in the Y direction on the display area 3a, the rate Ry is 0 (zero).

Therefore, the position of the finger F in the Y direction can be estimated by the equation (2) based on the amounts of light received of reflected lights of lights emitted from the light emitting sections 6b and 6c.

Estimation of the position of the finger F in the Z direction will be described.

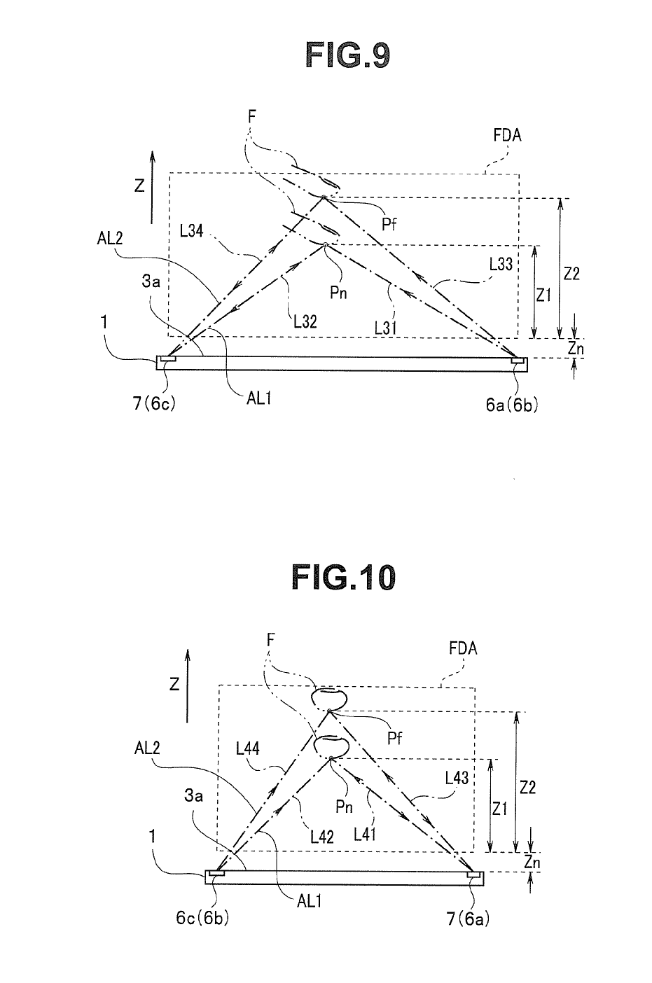

FIG. 9 is a diagram for illustrating the optical paths through which lights emitted from the light emitting sections 6 are received by the light receiving section 7 seen from a left side of the tablet terminal 1. FIG. 10 is a diagram for illustrating the optical paths through which lights emitted from the light emitting sections 6 are received by the light receiving section 7 seen from an upper side of the tablet terminal 1. In FIGS. 9 and 10, the upper surface of the tablet terminal 1 is the surface of the display area 3a.

A light with a predetermined wavelength is emitted at the light emission timing of each light emitting section 6. When a material body, the finger F here, is on the display area 3a, a reflected light reflected by the finger F enters the light receiving section 7. The amount of the reflected light entering the light receiving section 7 is inversely proportional to a square of a distance to the material body.

Note that, in FIGS. 9 and 10, a position on a surface of skin of the finger F nearest to the display area 3a will be described as the position of the finger F. In FIGS. 9 and 10, a position Pn of the finger F is a position separated from a lower surface of the motion judgment space FDA by a distance Z1, and a position Pf of the finger F is a position separated from the lower surface of the motion judgment space FDA by a distance Z2. The distance Z2 is longer than the distance Z1.

When the finger F is at the position Pn, a light emitted from each of the light emitting sections 6a and 6b passes through optical paths L31 and L32 in FIG. 9 and through optical paths L41 and L42 in FIG. 10, and then enters the light receiving section 7. When the finger F is at the position Pn, the light emitted from each of the light emitting sections 6a and 6b passes through optical paths L33 and L34 in FIG. 9 and through optical paths L43 and L44 in FIG. 10, and then enters the light receiving section 7. When the finger F is at the position Pn, a light emitted from the light emitting section 6c passes through the optical path L32 in FIG. 9 and through optical paths L41 and L42 in FIG. 10, and then enters the light receiving section 7. When the finger F is at the position Pf, the light emitted from the light emitting section 6c passes through the optical path L34 in FIG. 9 and through optical paths L43 and L44 in FIG. 10, and then enters the light receiving section 7.

When the case where the finger F is at the position Pn and the case where the finger F is at the position Pf, which is farther from the display area 3a than the position Pn, are compared, an amount of light AL1 at the time of the light emitted from the light emitting section 6 passing through the optical paths L31 and L32 and entering the light receiving section 7 is larger than an amount of light AL2 at the time of the light passing through the optical paths L33 and L34 and entering the light receiving section 7.

Accordingly, a sum SL of amounts of light received of lights from the three light emitting sections 6, which are received by the light receiving section 7, is determined by a following equation (3).

SL=(ALa+ALb+ALc) (3)

The amount of light of each of lights from the three light emitting sections 6 which have been reflected by the finger F and have entered the light receiving section 7 is inversely proportional to a square of a distance of the finger F in a height direction (that is, the Z direction) above the display area 3a.

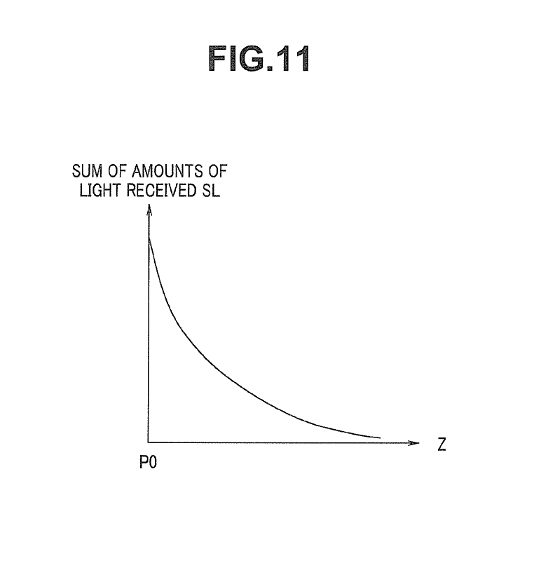

FIG. 11 is a graph showing a relationship between the position of the finger F in the Z direction and the sum SL of the three amounts of light received. In the Z direction, the sum SL of the three amounts of light received increases when the finger F is near the display area 3a, and the sum SL of the three amounts of light received decreases when the finger F is away from the display area 3a.

Therefore, the position of the finger F in the Z direction can be estimated by the above equation (3) based on the amount of light received of reflected light of lights emitted from the light emitting sections 6a, 6b and 6c.

Note that, though the amounts of light emitted of the three light emitting sections 6 are a same value EL in the example stated above, the amounts of light emitted of the three light emitting sections 6 may differ from one another. In this case, corrected amounts of light received is used in the above-stated equation in consideration of difference among the amounts of light emitted, to calculate each of the percent and the sum of the amounts of light received.

As described above, by calculating a position on a two-dimensional plane parallel to the display surface and a position in a direction intersecting the display surface at a right angle based on three amounts of light obtained by detecting respective lights emitted from the three light emitting sections 6, from a material body, by the light receiving section 7, a position of the material body is detected. Especially, the position on the two-dimensional plane parallel to the display surface is determined from a position in a first direction on the two-dimensional plane calculated with values of a difference between and a sum of two amounts of light and a position in a second direction different from the first direction on the two-dimensional plane calculated with values of a difference between and a sum of two amounts of light.

Then, the position in the direction intersecting the display surface at a right angle is determined with a value of the sum of the three amounts of light. Note that the position in the Z direction may be determined from two amounts of light instead of using three amounts of light.

Therefore, each time the three amounts of light received ALa, ALb and ALc are obtained, the position of the finger F within the three-dimensional space can be calculated with the use of the above equations (1), (2) and (3). As shown in FIG. 4, position information about the finger F within the three-dimensional space is calculated at each of the timings t1, t2, . . . .

### (Operation)

Next, an operation of the tablet terminal 1 which is the above-stated information terminal apparatus will be described.

By using the tablet terminal 1, the user can connect to a network such as the Internet to search for various kinds of information or perform Internet shopping and can execute application software for document creation or spreadsheet calculation stored in the storage section 15 to perform document creation and the like. In this case, the user can specify such processing using a graphical user interface (GUI) displayed on the display area 3a.

For example, at the time of performing information search using the Internet, the user causes a so-called web browser to be executed. The user inputs a search keyword using a software keyboard or the like and specifies execution of search by touching a predetermined icon on the browser. At the time of selecting a desired object from a group of objects displayed on the GUI, the selection is made by touching the desired object.

Specification of execution of the browser, input of a keyword, specification of execution of search, selection of an object or the like is performed by an operation of the user's finger or the like touching the screen of the display area 3a. However, in conventional information terminal apparatuses, a motion of the user's finger before the touch operation is not acquired. The tablet terminal 1, which is an information terminal apparatus of the present embodiment, detects motion information about the user's finger before the touch operation and transmits the motion information, for example, to a server.

A finger motion information transmitting process described below is a process for detecting such a motion of a finger or the like in the motion judgment space FDA before a touch operation, performing predetermined processing, and transmitting predetermined information when a touch operation is performed.

That is, the tablet terminal 1 of the present embodiment detects the above-stated motion of a finger or the like before a touch operation, which is different from the touch operation and executes predetermined processing based on information about a position or the like detected. Therefore, the process described below is executed in the background while the user is performing information search or the like.

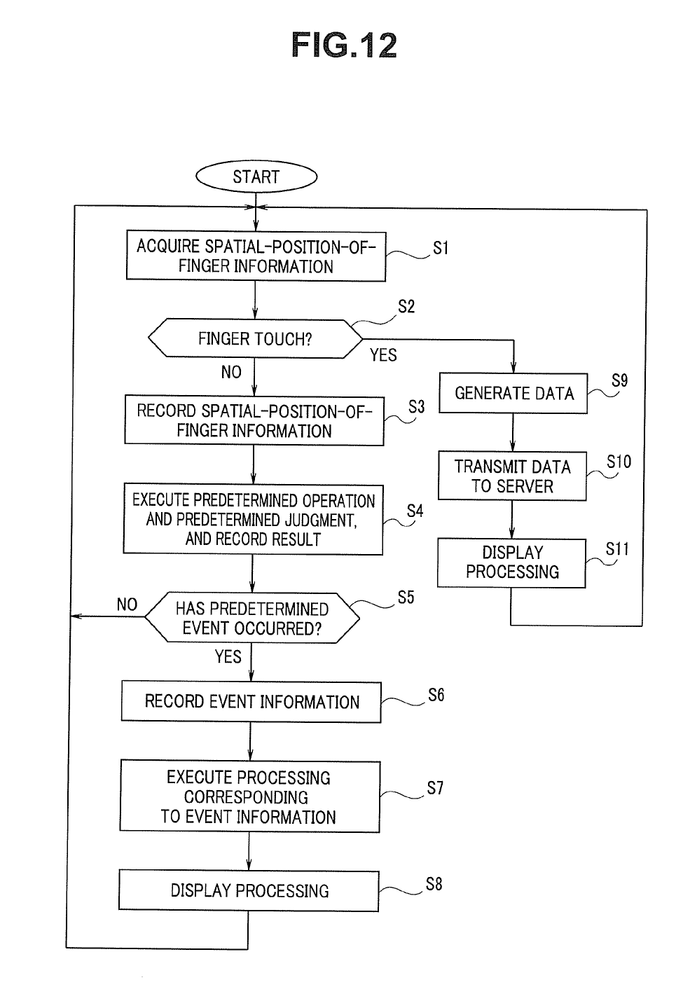

FIG. 12 is a flowchart showing an example of a flow of the finger motion information transmitting process. A finger motion information transmitting process program in FIG. 12 is stored in the ROM in the control section 11 or in the storage section 15 and read and executed by the CPU of the control section 11.

Note that the process in FIG. 12 may be adapted to be executed only when execution of the process is specified by the user.

The control section 11 acquires spatial-position-of-finger information, which is position information (xyz) about the finger F within the space including the motion judgment space FDA (S1). The control section 11 controls light emission of the three light emitting sections 6 and light receiving of the light receiving section 7 as shown in FIG. 4, and obtains position information about the finger F by calculating the position of the finger F using the above-stated equations (1), (2) and (3) from the amounts of light received of lights received from respective light emitting sections 6. At S1, the finger position in the three-dimensional space detected by the control section 11 is a position in the space including the motion judgment space FDA.

The control section 11 calculates values of the amounts of light received ALa, ALb and ALc corresponding to the respective light emitting sections 6 based on an outputted signal from the light receiving section 7, and calculates and determines spatial-position-of-finger information using the above-stated equations (1), (2) and (3). Note that the processing of S1 is executed in a predetermined cycle.

After S1, the control section 11 judges whether or not the finger touches the display area 3a (S2). The judgment of S2 is performed by monitoring output of the touch panel 13.

If there is not a touch by the finger (S2: NO), the control section 11 records the acquired spatial-position-of-finger information to a table TBL (S3). The table TBL is stored in the RAM in the control section 11 or in the storage section 15.

After S3, the control section 11 executes predetermined operation, predetermined judgment, and recording of an operation result and a judgment result (S4).

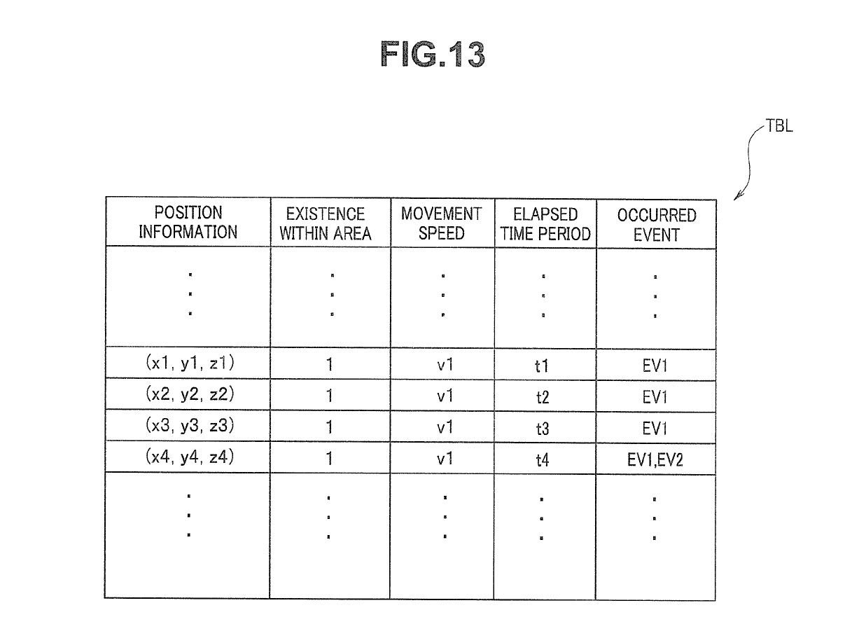

FIG. 13 is a diagram showing an example of the table TBL in which position information and the like are recorded. The table TBL in FIG. 13 has “position information (xyz)” about the finger F, “movement speed” of the finger F, “existence/nonexistence within area” indicating whether the finger F exists within the motion judgment space FDA, “elapsed time period” during which the finger F continuously exists within the motion judgment space FDA and “occurred event” as recording items.

If position information is acquired, and the finger F does not touch the touch panel 13, then the control section 11 records the acquired position information into the table TBL (S3), and, from the position information, performs judgment about whether or not the finger F exists in the motion judgment space FDA, calculation of movement speed of the finger F, calculation of an elapsed time period during which the finger F continuously exists within the motion judgment space FDA (S4). At S3, the control section 11 writes the spatial-position-of-finger information into a “position information” field of the table TBL. At S4, the control section 11 writes information of a result of the judgment whether or not the finger F exists within the motion judgment space FDA, the movement speed of the finger F, the elapsed time period during which the finger F continuously exists within the motion judgment space FDA into the three fields of “existence in area”, “movement speed” and “elapsed time period” in the table TBL.

Note that, the table TBL is a FIFO memory. As described later, though data such as the position information is recorded in the table TBL, only latest data is recorded while older data is erased when a predetermined volume is exceeded.

When the position information is acquired first, either the movement speed of the finger nor the elapsed time can be calculated. Therefore, only processing for whether or not the finger F exists in the motion judgment space FDA is executed, and the process proceeds to step S5.

After S4, the control section 11 judges whether a predetermined event has occurred or not (S5). Conditions for judging occurrence of a predetermined event are determined in advance and written in the finger motion information transmitting process program.

For example, when such a state occurs that the finger F exists in the motion judgment space FDA and has existed in the motion judgment space FDA for a predetermined time period, for example, two seconds or more, and the motion speed becomes a predetermined speed or below, it is judged that a certain predetermined event E1 has occurred.

If it is judged at S5 that a predetermined event has not occurred (S5: NO), the process returns to S1. The above process is repeated until a predetermined event occurs, as far as the touch panel 13 is not touched.

Thus, the control section 11 performs recording of the spatial-position-of-finger information (S3), predetermined operation and judgment, recording of results of the operation and judgment (S4) and judgment of occurrence of a predetermined event, in a predetermined cycle.

When a predetermined event occurs (S5: YES), the control section 11 records information about the occurred event to the table TBL (S6).

At S6, the control section 11 writes identification information about the event into the “occurred event” field of the table TBL. If multiple predetermined events are determined in advance, identification information corresponding to each event is written into the table TBL.

Then, the control section 11 executes predetermined processing according to the identification information about the occurred event written in the table TBL (S7).

For example, if processing of transmitting history information about the position information about the finger F recorded in the table TBL to a server acquiring a screen to be displayed on the display area 3a currently, via the communication section 14 is set in advance, as event processing EP1 in the case of occurrence of the above-stated predetermined event E1, then the event processing EP1 is executed.

In the case of Internet shopping, if the user places the finger F near a certain product on the screen of the display area 3a of the tablet terminal 1 on which a group of products for Internet shopping is displayed, without moving the finger F almost at all for a predetermined time period or more, then it can be presumed that the user is interested in the product.

Therefore, if, as the event E1, a detected finger position exists within the motion judgment space FDA (that is, a flag indicating existence, for example, “1” is recorded in the “existence within area” field in the table TBL) and a state that the movement speed of the finger is a predetermined speed or below within the motion judgment space FDA has continued for a predetermined time period or more, it is judged that the event E1 has occurred (S5). Then, in this case, the control section 11 executes processing for transmitting all data stored in the table TBL to the server as the event processing EP1 corresponding to the event E1.

Note that, as the event processing, only predetermined data may be transmitted instead of transmitting all data stored in the table TBL. For example, only the position information (xyz) about the finger F and the elapsed time period during which the finger F continuously exists within the motion judgment space FDA may be transmitted.

Furthermore, though all data stored in the table TBL is transmitted to the server as the event processing, all the data stored in the table TBL may be used for predetermined processing within the tablet terminal 1 without transmitting the data to the server.

Then, the control section 11 executes display processing (S8). The display processing is processing corresponding to predetermined event processing. For example, a server of an Internet shopping site generates image data to be displayed on the display area 3a, based on data received by event processing and transmits the image data to the tablet terminal 1. The tablet terminal 1 executes processing for displaying the received image data on the display area 3a. Such display processing is executed at S8.

Thus, when there is not a touch on the touch panel 13 by the finger F, event processing is executed each time a predetermined event occurs, and three-dimensional position data of the finger F is transmitted to the server by the event processing. Therefore, the server can acquire history information about objects the user is interested in when the user has not touched the touch panel 13, that is, when the user has not selected an object, and transmit auxiliary information such as advertisement to the tablet terminal 1.

Furthermore, when there is a finger touch on the touch panel 13 at S2 (S2: YES), the control section 11 generates data (S9) and transmits the data to the server (S10). The server performs image data generation processing and the like corresponding to the received data, and transmits generated image data to the tablet terminal 1. The control section 11 of the tablet terminal 1 executes display processing corresponding to the received image data (S11).

At S9 and S10, since the user has selected any object if there is a finger touch on the touch panel 13, the control section 11 transmits information about the selected object to the server as well as transmitting data stored in the table TBL to the server.

That is, at S9, the information about the selected object and data to be transmitted (all or a part) among data stored in the table TBL are generated, and transmission of the data generated at S9 is performed at S10.

In the display processing of S11, for example, the server of the Internet shopping site generates image data to be displayed on the display area 3a, based on the received data and transmits the image data to the tablet terminal 1. The tablet terminal 1 executes the processing for displaying the received image data on the display area 3a. Such display processing is executed at S11.

After S8 and S11, the process returns to S1. As a result, when the user operates the tablet terminal 1, detection of a position of the finger in the three-dimensional space, calculation of the movement speed of the finger, judgment of existence/nonexistence of the finger within the motion judgment space FDA and judgment of a time period during which the finger continuously exists within the motion judgment space FDA. Then, occurrence of a predetermined event is judged based on the above detection, calculation and judgments. When occurrence of an event is detected, processing corresponding to the occurred event is executed.

A specific example will be described.

When the user is performing Internet shopping, there may be a case where the finger wanders before choosing a product on the display area 3a. When a product which the user wants to purchase or the details of which he wants to confirm is decided, the user's finger selects the product object, that is, the user's finger touches an image of the product on the touch panel 13.

However, at a stage before a product is decided, a state exits that the user is undecided about selection of a product which he wants to purchase.

If the user is not undecided about selection of a product, the user's finger touches the touch panel 13 immediately after entering the motion judgment space FDA. In this case, change from information indicating that a predetermined event has not occurred (S5: NO) to a state that there is a finger touch (S2: YES) occurs at once. Therefore, in this case, information about a selected object is generated in data generation of S9, and only a little position information stored in the table TBL is transmitted (S10).

In comparison, when the user is undecided about selection of a product, and the user's finger moves slowly or stops after entering the motion judgment space FDA, without touching the touch panel 13 at once, occurrence of a predetermined event set in advance is detected (S5: YES).

Multiple predetermined events may be set, and it is possible to cause an event to occur according to a motion of a finger.

When the motion of the finger becomes slow, and a predetermined time period elapses, it can be thought that the user is interested. Therefore, a predetermined event occurs, and, for example, processing for transmitting finger motion information to the server of the shopping site is executed as processing corresponding to the occurred event (S7).

Even if an event does not occur, position information about the user's finger after the finger entering the motion judgment space FDA is recorded to the table TBL (S3). Therefore, when the finger touches the touch panel 13 (S2: YES), history information about the position information about the finger in the three-dimensional space recorded in the table TBL is transmitted to the server (S10).

Since the server grasps image information transmitted to the tablet terminal 1, the server can analyze which product object the finger has passed near, from the finger motion information. That is, though the server can conventionally obtain only information about an object the user selects in the end, the server can also obtain information about an object which the user seems to have got interested in. The object the user may have got interested in can be said to be a selection candidate.

As a result, the server generates optimal advertisement information, word-of-mouth information, evaluation information and the like based on information about an object which the finger approached passing slowly or staying temporarily, and transmits the information to the tablet terminal 1 as auxiliary information. That is, it is possible to perform marketing of selection-candidate product objects based on the finger position information.

The tablet terminal 1 executes display processing for displaying advertisement information transmitted from the server (S8), and advertisement about a product object which the finger approached passing slowly or staying temporarily before the user selecting a product object is displayed on the display area 3a. As a result, it is possible to enhance the user's purchase desire.

The above example is an example of application to display of advertisement in Internet shopping. In information search and the like also, it is possible to present related information about an object which the finger approached passing slowly or staying temporarily to the user.

Since the server can identify, from the received position information about the finger F, an object corresponding to the position information, the server transmits auxiliary information and the like related to the object, to the tablet terminal 1.

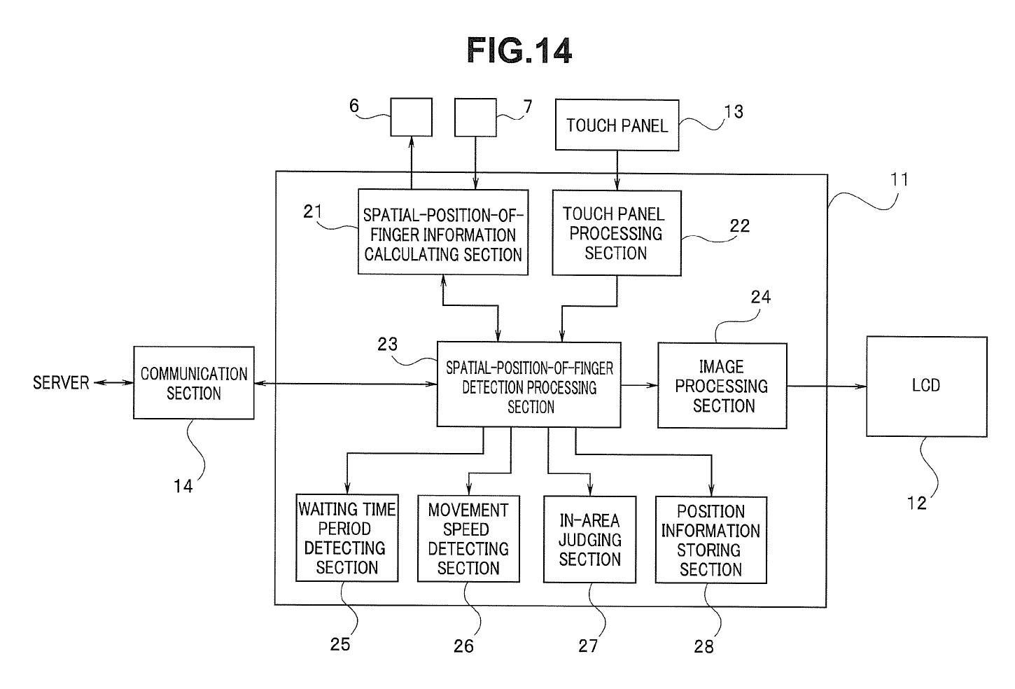

FIG. 14 is a block diagram showing components for the finger motion information transmitting process in FIG. 12. The control section 11 as a finger motion information transmitting section includes a spatial-position-of-finger information calculating section 21, a touch panel processing section 22, a spatial-position-of-finger detection processing section 23, an image processing section 24, a waiting time period detecting section 25, a movement speed detecting section 26, an in-area judging section 27 and a position information storing section 28.

The spatial-position-of-finger information calculating section 21 is a processing section configured to calculate a finger position on a three-dimensional space using the above-stated equations (1), (2) and (3) based on information about an amount of light received of the light receiving section 7 at each light emission timing of the light emitting sections 6, and the spatial-position-of-finger information calculating section 21 corresponds to a processing section of S1 in FIG. 12. Therefore, the processing of S1 and the spatial-position-of-finger information calculating section 21 constitute a position detecting section configured to detect a position of a material body in a space which includes a predetermined three-dimensional space (xyz) set in advance separated from the display surface of the display device 3.

The touch panel processing section 22 is a processing section configured to detect an output signal from the touch panel 13 and detect information about a position touched on the touch panel 13, and the touch panel processing section 22 corresponds to a processing section of S2 in FIG. 12. Therefore, the processing of S2 and the touch panel processing section 22 constitute a touch panel touch detecting section configured to detect that the touch panel 13 of the display device 3 has been touched.

The spatial-position-of-finger detection processing section 23 is a processing section configured to perforin judgment of occurrence of a predetermined event and execution of processing corresponding to the occurred event, and the spatial-position-of-finger detection processing section 23 corresponds to a processing section of S5 to S7 in FIG. 12. Therefore, the processing of S5 to S7 and the spatial-position-of-finger detection processing section 23 constitute a position information transmitting section configured to transmit position information about a material body in the motion judgment space FDA, which is a predetermined space, detected by the position detecting section before the touch panel 13 is touched.

Especially, the processing of S5 constitutes an event detecting section configured to detect occurrence of an event determined in advance, based on speed of a material body and an elapsed time period during which the material body continuously exists in the predetermined space.

The image processing section 24 is a processing section configured to perform display processing corresponding to image data received from a server or image data generated in the tablet terminal 1, and the image processing section 24 corresponds to a processing section of S8 and S11 in FIG. 12.

The waiting time period detecting section 25 is a processing section configured to calculate and detect an elapsed time period during which a user's finger continuously exists in the motion judgment space FDA, and the waiting time period detecting section 25 corresponds to a processing section of S4 in FIG. 12. Therefore, the processing of S4 and the waiting time period detecting section 25 constitute an elapsed time period detecting section configured to detect an elapsed time period during which a material body continuously exists in the motion judgment space FDA which is a predetermined space.

The movement speed detecting section 26 is a processing section configured to detect movement speed of a user's finger, and the movement speed detecting section 26 corresponds to a processing section of S4 in FIG. 12. Therefore, the processing of S4 and the movement speed detecting section 26 constitute a speed detecting section configured to detect a speed of a material body based on position information about the material body existing in the motion judgment space FDA which is a predetermined space.

The in-area judging section 27 is a processing section configured to judge whether or not a finger exists within the motion judgment space FDA, and the in-area judging section 27 corresponds to a processing section of S4 in FIG. 12. Therefore, the processing of S4 and the in-area judging section 27 constitute an existence-in-predetermined-space judging section configured to judge whether or not a material body exists in the motion judgment space FDA which is a predetermined space.

The position information storing section 28 is a processing section configured to store finger position information into a table TBL which is a storage section, and the position information storing section 28 corresponds to a processing section of S3 in FIG. 13. Therefore, the processing of S3 and the position information storing section 28 constitute a history information storing section configured to store history information which includes position information about multiple positions corresponding to motions of a material body before the touch panel 13 is touched, into a storage device such as the storage section 15.

Note that the above-stated finger motion information transmitting process in FIG. 12 has the multiple processing blocks shown in FIG. 14. All the processing blocks may be realized by software, or a part or all of the processing blocks may be realized by hardware.

As described above, according to the information processing terminal of the present embodiment, it is possible to provide an information terminal apparatus acquiring motions of a material body such as a finger before an object is decided by a touch operation and transmitting acquired motion information.

Note that, though a finger position in a three-dimensional space is detected with the use of multiple light emitting sections and one light receiving section in the example stated above, the finger position in the three-dimensional space may be acquired by image processing with the use of two camera devices, in the case of a relatively large-size apparatus such as a digital signage.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. An information terminal apparatus comprising:
a display device equipped with a touch panel;
a position detecting section configured to detect a position of a material body in a space which includes a predetermined three-dimensional space set in advance separated from a display surface of the display device; and
a position information transmitting section configured to transmit position information about the material body in the predetermined space detected by the position detecting section before the touch panel is touched.

2. The information terminal apparatus according to claim 1, comprising a history information storing section configured to store history information which includes the position information about multiple positions corresponding to motions of the material body before the touch panel is touched, into a storage device; wherein
the position information transmitting section transmits the history information stored in the storage device as the position information about the material body.

3. The information terminal apparatus according to claim 2, comprising a touch panel touch detecting section configured to detect that the touch panel of the display device is touched; wherein
when the touch panel touch detecting section detects that the touch panel is touched, the position information transmitting section transmits the history information stored in the storage device as the position information about the material body.

4. The information terminal apparatus according to claim 2, comprising an elapsed time period detecting section configured to detect an elapsed time period during which the material body continuously exists in the predetermined space; wherein
the history information includes information about the elapsed time period detected by the elapsed time period detecting section.

5. The information terminal apparatus according to claim 4, comprising a speed detecting section configured to detect a speed of the material body based on the position information about the material body existing in the predetermined space; wherein
the history information includes information about the speed detected by the speed detecting section.

6. The information terminal apparatus according to claim 5, comprising an event detecting section configured to detect occurrence of an event determined in advance, based on the speed and the elapsed time period; wherein
when the event detecting section detects occurrence of the event, the position information transmitting section transmits the history information.

7. The information terminal apparatus according to claim 6, wherein the history information includes information about the event.

8. The information terminal apparatus according to claim 1, wherein the position information transmitting section transmits the position information about the material body to a server transmitting image data displayed on the display surface of the display device.

9. The information terminal apparatus according to claim 1, comprising:
first, second and third light emitting sections arranged around the display surface of the display device; and
a light receiving section arranged around the display surface; wherein
the position detecting section detects a first position on a two-dimensional plane parallel to the display surface and a second position in a direction intersecting the display surface at a right angle based on first, second and third amounts of light obtained by detecting respective reflected lights of lights emitted from the first, second and third light emitting sections, from the material body, by the light receiving section.

10. The information terminal apparatus according to claim 9, wherein the position detecting section determines the first position from a position in a first direction on the two-dimensional plane calculated with values of a difference between and a sum of the first and second amounts of light and a position in a second direction different from the first direction on the two-dimensional plane calculated with values of a difference between and a sum of the second and third amounts of light.

11. The information terminal apparatus according to claim 9, wherein the position detecting section determines the second position in the direction intersecting the display surface at a right angle with a value of a sum of at least two amounts of light among the first, second and third amounts of light.

12. The information terminal apparatus according to claim 9, wherein
the first, second and third light emitting sections emit lights at mutually different timings, and the light receiving section detects the reflected lights of the lights emitted from the respective first, second and third light emitting sections according to the different timings.

13. The information terminal apparatus according to claim 9, wherein the first, second and third light emitting sections emit lights with a wavelength outside a wavelength range of visible light.

14. The information terminal apparatus according to claim 13, wherein the light with a wavelength outside the wavelength range of visible light is a near-infrared light.

15. An information terminal apparatus comprising:
a display device equipped with a touch panel;
first, second and third light emitting sections arranged around the display surface of the display device;
a light receiving section arranged around the display surface;
a touch panel touch detecting section configured to detect that the touch panel of the display device is touched;
a position detecting section configured to detect a position of a material body in a space which includes a predetermined three-dimensional space set in advance separated from a display surface of the display device, based on first, second and third amounts of light obtained by detecting respective reflected lights of lights emitted from the first, second and third light emitting sections, from the material body, by the light receiving section.
an elapsed time period detecting section configured to detect an elapsed time period during which the material body continuously exists in the predetermined space;
a speed detecting section configured to detect a speed of the material body based on position information about the material body existing in the predetermined space;
a history information storing section configured to store history information which includes the position information about multiple positions corresponding to motions of the material body before the touch panel is touched, into a storage device; and
a position information transmitting section configured to transmit the position information about the material body in the predetermined space detected by the position detecting section before the touch panel is touched and information about the elapsed time and the speed as the history information.

16. The information terminal apparatus according to claim 15, comprising an event detecting section configured to detect occurrence of an event determined in advance, based on the speed and the elapsed time period; wherein
when the event detecting section detects occurrence of the event, the position information transmitting section transmits the history information.

17. The information terminal apparatus according to claim 16, wherein the history information includes information about the event.

18. The information terminal apparatus according to claim 15, wherein the position detecting section determines the first position from a position in a first direction on the two-dimensional plane calculated with values of a difference between and a sum of the first and second amounts of light and a position in a second direction different from the first direction on the two-dimensional plane calculated with values of a difference between and a sum of the second and third amounts of light.

19. The information terminal apparatus according to claim 15, wherein the position detecting section determines the second position in the direction intersecting the display surface at a right angle with a value of a sum of at least two amounts of light among the first, second and third amounts of light.

20. The information terminal apparatus according to claim 15, wherein the first, second and third light emitting sections emit lights at mutually different timings, and the light receiving section detects the reflected lights of the lights emitted from the respective first, second and third light emitting sections according to the different timings.
